(19) United States
(12) Patent Application Publication
(10) Pub. No.: US 2016/0202425 A1
(43) Pub. Date: Jul. 14, 2016

(54) CARRIER SYSTEM FOR MICRO-OPTICAL AND/OR OTHER FUNCTIONAL ELEMENTS OF MICROTECHNOLOGY

(71) Applicants: FRAUNHOFER-GESELLSCHAFT ZUR FOERDERUNG DER ANGEWANDTEN FORSCHUNG E.V., Muenchen (DE); TECHNISCHE UNIVERSITAET BERLIN, Berlin (DE)

(72) Inventors: HENNING SCHROEDER, Berlin (DE); NORBERT ARNDT-STAUFENBIEL, Berlin (DE); SEBASTIAN MARX, Berlin (DE); GUNNAR BOETTGER, Berlin (DE)

(21) Appl. No.: 14/988,783

(22) Filed: Jan. 6, 2016

(30) Foreign Application Priority Data
Jan. 8, 2015 (DE) 10 2015 200 123.7

(51) Int. Cl. G02B 6/36

(52) U.S. Cl. CPC G02B 6/3648

(57) ABSTRACT

The present invention relates to a carrier system for micro-optical and/or other functional elements of microtechnology, including a base plate and one or more retaining elements for the functional elements that are secured on the base plate. The suggested carrier system is characterized by the fact that the retaining elements are constructed partly or entirely from multiple thin, stacked plates that have a plate thickness of less than 1 mm. In this way, retaining elements for example made from glass or glass ceramic may be created extremely precisely in practically any geometrical shape.

### TECHNICAL FIELD

The present invention relates to a carrier system for micro-optical and/or other functional elements of microtechnology, including a base plate and one or more retaining elements for the functional elements that are secured on the base plate.

If optoelectronic components in particular, such as semiconductor lasers, photodiodes or modulators with micro-optical components such as microlenses, gratings and prisms, and connecting elements, such as optical fibres, for example, are arranged in hybrid manner on a platform, this is called a micro-optical bench. As with a macro-optical bench, these functional elements must be aligned, so special retaining elements have to be provided that are capable of compensating for different heights or angular settings, or which themselves serve as alignment aids for the functional elements.

### PRIOR ART

In the past, carrier systems of such kind were created using an enormous variety of materials and techniques. However, the previously known solutions have always been highly application-specific and specialised, and they therefore do not lend themselves to general use, nor can they be adapted easily to other applications. In this context, a distinction must be made between the following techniques.

In one known technique, stepped, terraced or otherwise structured base plates are produced from a block of material in casting, moulding or material removal processes. Such a base plate is revealed for example in the publication by S. Heinemann et al., “Compact High Brightness Diode Laser Emitting 500 W from a 100 μm Fiber” in: High-Power Diode Laser Technology and Applications XI, Proc. SPIE Vol. 8605, 2013, pages 86050Q-1 to 86050Q-7, or DE 19780124 B4. With such stepped structures in the base plate, it is possible to give the functional elements used various structural heights.

In another technique, metal V-steps, eyes, brackets, landings and aligning elements are fixed on a planar base plate made of silicon, glass, metal or ceramic using various bonding methods. Such a technique is known for example from www.ingeneric.com/pdf/V-STEP-MODULE_INGENERIC.pdf.

A further technique uses MEMS structures made from SU8, silicon or ceramic, for example, on substrates of silicon, glass, metal or ceramic, and which have been subjected to complex lithography processing. Other techniques are also known in which carrier structures are created in substrates of silicon, glass, metal or ceramic by ultraprecision machining.

Document EP 0864893 A3 shows a modular coupling system for optical fibre structures, in which different components are conformed suitably and then connected to each other to provide mechanical limit stops and guides for positioning optical fibres.

More than any other material, glass lends itself extremely well to the purpose of constructing micro-optical benches because of its dimensional stability and reliability. However, it has not yet proven possible with current microsystem equipment to produce retaining elements for micro-optical and/or other microtechnical functional elements from glass that are small enough, with a size in the range from a few μm to a few mm, and in the necessary shapes for the retaining function. Techniques such as 3D printing and subsequent sintering processes or glass etching processes do not deliver the precision that is essential for many applications. On the other hand, the functional elements are often not manufactured with sufficient precision, particularly in the case of inexpensive products, and must be aligned extremely precisely and accurately in as many as six degrees of freedom. The retaining elements used on the carrier system must allow such an alignment, for example for beam positioning, for alignment within an assembly or for extremely precise securing by minimising bonding gaps. Until now, a technique with correspondingly high precision and flexibility, which can be adapted without difficulty to many applications, has not existed.

The object of the present invention consists in describing a carrier system for micro-optical and/or other functional elements of microtechnology, which can also be prepared with extreme precision on a glass or glass ceramic base and can be adapted without difficulty to an extremely wide variety of applications.

### SUMMARY OF THE INVENTION

This object is achieved with the carrier system according to claim 1. Advantageous embodiments of the carrier system are subject of the dependent claims, or may be deduced from the following description and exemplary embodiments.

The suggested carrier system for micro-optical and/or other functional elements of microtechnology includes a base plate and one or more retaining elements for the functional elements, wherein the retaining elements form raised structures and are secured, i.e. fixed, on the base plate. In this context, microtechnology is understood to be a technical area in which at least some of the functional elements involved have at least one dimension that measures ≦1 mm. Examples are the fields of micromechanics, microelectronics, micro-optics or microfluidics. Functional elements are components from these fields that perform a corresponding optical, electronic, mechanical or fluidic function. However, the retaining elements in the suggested carrier system can generally also support functional elements whose smallest dimension is even as much as several mm, for example correspondingly thicker optical fibres. In the suggested carrier system, the retaining elements are constructed partly or entirely from thin, stacked plates that typically have a plate thickness of less than 1 mm.

These thin plates may be bonded to each other by connecting elements without adhesive or also by a wide variety of bonding techniques. In case of adhesiveless connections the connecting elements may be, e.g., metal pin elements, that result in a clamping fixture when ductile material is worked while cold. The connecting elements may also be clips, mountings or shaped settings. In a connection using a bonding technique, bonding methods or—in the case of glass materials—glass-glass bonding may be used to connect the thin plates. The thin plates do not necessarily have to lie closely one on top of the other to form the retaining elements, they may also be located at a distance from each other, particularly if the connection is assured via connecting elements.

As the retaining elements are constructed of thin, stacked plates, the retaining elements may be created in a very wide range of sizes and shapes, depending on their intended application. Unlike solid blocks of material, thin plates can be structured very easily and with very good precision especially in glass and glass ceramic materials. The plates are then aligned with each other and secured correspondingly relative to each other to form the retaining element. By using plates of different lateral dimensions (length/width) or external shapes and/or different structuring, it is thus possible to create retaining elements in a wide variety of geometrical shapes therefrom, even with undercuts, for example, and corresponding structures. In this context, the term structuring of the plates is understood to mean the formation of passthroughs of any geometrical shape in the plates or the corresponding moulding of the contours or borders of the plate. Such structures in thin plates may be formed with simple cutting techniques, particularly by means of laser cutting, for example with a green laser or a CO₂ laser, by water jet cutting or etching techniques. Preferably the thin plates have lateral dimensions, at least one of which, i.e. their length or their width, is smaller than 50% of the length or of the width of the base plate.

In the suggested carrier system, the thin plates of the retaining elements preferably consist of a glass or a glass ceramic, since these materials are particularly well suited to micro-optical and other microtechnical applications due to their dimensional stability and reliability. At the same time, different plates may be made from different glasses or glass ceramics. Thin plates of glass are available commercially, and can be dimensioned laterally and also structured extremely precisely using the cutting techniques described above.

The base plate of the carrier system preferably also consists of a glass or glass ceramic, since these materials provide a very flat surface as well. The base plate may be of solid construction from the glass or glass material, but preferably also consists of several thin stacked plates having a plate thickness typically less than 1 mm. These thin plates for forming the base plate may be coated, for example with a metallic substance, to perform a thermal function, for example, and they may be connected to each other by a bonding technology.

The construction of the base plate from a plurality of stacked thin plates means that, again, many different structures can be made in the base plate simply and with a high degree of precision. In such a context, the base plate may contain holes, metal connectors, such as bumps for alignment, thermal vias or electrical feed lines, connection interfaces for feed lines, e.g., detachable vacuum connectors or fluidic connectors, and horizontal tubes for fluid media, gases or a vacuum, for example. Detachable vacuum connectors may be necessary for vacuum-supported construction processes when securing the retaining elements or to assure functionality during operation. The fluid connectors may be detachable or permanently attached fluid connectors.

In the suggested carrier system, the retaining elements may be constructed and connected to the base plate in such manner that the thin plates of the retaining elements are stacked horizontally relative to the surface of the base plate. The horizontal stacking method enables steps to be created, or passthroughs for receiving pins or dowel pins, or also a thermal, fluid passthrough, and other purposes in the retaining elements.

However, the retaining elements, or at least some of the retaining elements, may be designed and attached to the base plate in such manner that the thin plates of the retaining elements are stacked vertically relative to the surface of the base plate. The vertical stacking method enables functional elements to be accommodated between individual plates of the retaining elements by positive and/or force-fitting clamping, e.g. functional elements such as optical filters, gratings or mirrors, or by holes into which correspondingly shaped functional elements, e.g. optical fibres, may be inserted. The vertical stacking technique further enables the functional elements to be accommodated in a cavity or ribbed mounting on the upper side of the retaining element, that is to say on the borders of the plates. In this context, the functional elements may be affixed to the retaining elements by adhesion, for example. This applies particularly for mechanical functional elements or optical functional elements such as rod lenses and spherical lenses, other lenses, gratings, prisms and the like. The vertical stacking arrangement further enables the accommodation of rotating axes, to which in turn other structures may be attached. In this way, degrees of rotational freedom are preserved for the mounted elements, and particularly to create gimbal arrangements, hinges or torsion elements. In principle, the retaining elements may also include flat areas with especially concave structures or reservoirs for adhesion, or retaining structures that have been adapted in form to a universal gripper tool in an assembly machine by special external moulding. In addition, the integration of pipes or channels for enabling a vacuum connection via the base plate may be assured by introducing slots into individual plates.

Retaining elements are also possible in which the plates in the stack are neither exactly horizontal nor vertical, but are aligned at an angle to the base plate, and horizontal and vertical stacking arrangements of thin plates may also be combined to create more complete retaining elements, for example in a crossing or interlaced arrangement.

Besides the thin stacked plates, and possibly connecting elements, the retaining elements may also contain further components, such as a landing or a suitable attachment, made of anisotropically or isotropically structured silicon plates, in order to be able to produce easily defined gradients, for example.

Since the thin plates can be structured and dimensioned (laterally) with complete freedom and extreme precision, and these can then be combined to create corresponding retaining elements, a universal methodological approach is provided for creating arbitrarily discretely shaped and/or structured retaining elements with correspondingly small dimensions in the carrier system. The suggested retaining elements and construction techniques lend themselves well to industrial manufacturing from small-volumes to mass production particularly when the advantageous glass or glass ceramic materials are used, as the manufacturing and construction steps lend themselves so well to automation. Thus, thin glass plates can be made in large lateral sizes, for example in A4 or A3 format. In this way, the thin plates, or even the entire retaining elements, may be produced in a panel production process. One possibility consists in structuring and cutting out several thin plates side by side in a large format thin glass plate at the same time, and then aligning them with thin plates that have been produced in the same way from the same or different thin glass plates in stacks one on top of the other and connecting them with each other. This enables efficient production in cases in which it is less expensive to produce many individual plates and to stack them afterwards, or in cases in which they are to be combined with plates made from other materials. The further option exists to stack the large-format thin glass plates one on top each other and connect them first, and then to cut out and optionally to structure the entire stack using a cutting technique, for example laser cutting with a green laser. Of course, individual production of the single thin plates and retaining elements is also possible in all cases.

Various possibilities exist for the opposing fixture of the thin plates, e.g., pinning by attaching with guide pins or bonding techniques. In the case of the bonding techniques, processes with additive materials may be used—bridging the gap—such as adhesive bonding, soldering or silicate bonding. Bonding techniques without additives—gapless—such as optical contact bonding, direct bonding (glass-glass bonding) or laser bonding may also be used.

The proposed carrier system is particularly suitable for the use of glasses or glass ceramics, as materials for the thin, stacked plates. In principle, however, the proposed technique may also be applied to other materials, e.g., plastic or ceramic materials, in which case many of the advantages listed in the preceding apply in the same way. In principle, both the base plate and the retaining elements may also be constructed from thin plates of different materials.

The suggested carrier system particularly enables the implementation of a highly precise, economical, large format layout technology for manufacturing multilayer packaging (AVT) made of glass with subsequent depanelisation. Accordingly, 2.5D micro-optical benches, substrates that have been functionalised (mechanically, optically, fluidically, electrically, with regard to thermal conductivity) or also modular microsystem technology (MST) can be realised. The concept according to the invention for constructing the carrier system enables a heterogeneous system integration of different functional elements, for example the production of micro-optical benches for dynamic, highly precise positioning in six degrees of freedom on extremely planar substrates. The suggested carrier system then makes it possible for the coefficient of thermal expansion to be adapted. The carrier system further makes it possible to reduce costs in manufacturing through the use of commercially available heat-polished float or pulled glass panes or films (draw-down method), with naturally very low thickness tolerances and high evenness. It follows that no further cost intensive polishing steps are necessary, such as are required with metal substrates. Fully automatic assembly is also possible for creating the carrier system. The use of optically transparent glass materials means that no shadowing occurs when UV bonds are created or laser bonding is used to connect individual plates or components.

The plates from which the retaining elements and/or the base plate are constructed do not have to be plane-parallel in every case. Thus for example, a wedge shape is also possible, so that the retaining elements can then be constructed from wedge-shaped plates, for example. Moreover, the carrier system may also comprise additional retaining elements that are not constructed from stacked, thin plates. The suggested carrier system can be used in many electronic, optical, mechanical, fluidic and combined applications. Examples of such uses include laser modules for telecommunications, optical measurement equipment or laser material machining, sensor systems with synchronised micro-optics, bioanalysis measurement systems, measurement cells for microreaction equipment, fuel cells, optical measurement cells for chemical analysis, microprojection modules, lighting elements, highly dimensionally and thermally stable micro-optical systems for measuring instruments such as interferometers, functionalised vacuum passthroughs, free space optical communication equipment (terrestrial, space), minispectrometers, optical design elements and MEMS systems with transparent and functionalised encapsulation. Of course, this list is not exhaustive.

### BRIEF DESCRIPTION OF THE DRAWINGS

In the following, the proposed carrier system will be explained again, in greater detail, in conjunction with the drawings and with reference to exemplary embodiments thereof. In the drawings:

FIG. 1 shows a simplified example of an embodiment of the proposed carrier structure with base plate and one retaining element;

FIG. 2 shows an example of a retaining element in which the thin plates are connected to each other and kept at a distance from each other by pins;

FIG. 3 shows two examples of a vertically stacked retaining element with a functional element positioned thereon;

FIG. 4 shows an example of a retaining element with a rotating axis; and

FIG. 5 shows an example of a horizontally stacked retaining element.

### MODES FOR CARRYING OUT THE INVENTION

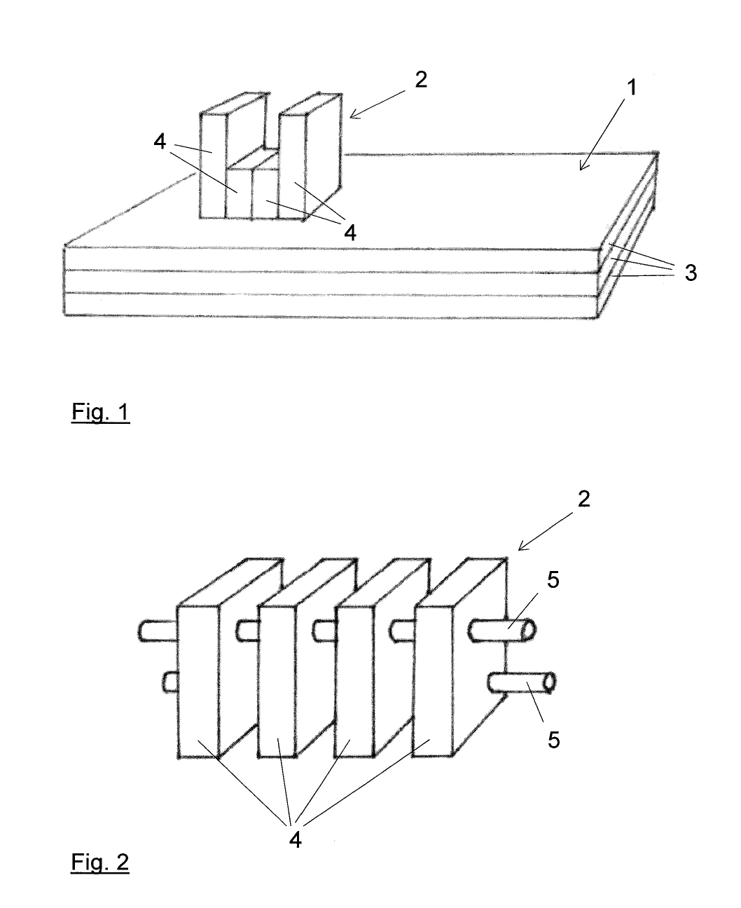

The proposed carrier system has a base plate and one or more retaining elements for the functional elements. At least some of the retaining elements are constructed from a plurality of thin stacked plates. In this regard, FIG. 1 shows a simplified representation of an example of such a carrier system, which in this example comprises only base plate 1 with a retaining element 2 fixed on top thereof. In this example, base plate 1 is also constructed from a plurality of stacked thin plates 3, as may be seen in the figure. Retaining element 2 in this example is constructed from vertically stacked thin plates 4, of which the two outer plates are higher than the two inner plates. Fastening of plates 4 to each other may be assured with glass-glass bonding, for example, when glass plates are used. Retaining element 2 may be secured on base plate 1 by a bonding technique, for example. As a rule, in most applications several retaining elements 2 constructed either identically or differently will be affixed to base plate 3. In the form shown here, retaining element 2 may accommodate a functional element, which may be of suitable size and shape so as to be clamped between the two outer thin plates 4.

Thin plates 4 of a retaining element 2 do not necessarily have to be in contact with each other. They may also be arranged at a distance from each other, as is shown in the example of FIG. 2. For this purpose, FIG. 2 shows a retaining element 2 in which the thin plates 4 are connected to retaining element 2 via pins 5. The individual plates 4 have been structured in this case by the formation of passthroughs, through which it is possible to insert pins 5—made from metal for example. The mutual fastening may be assured by a positive or force-fitting connection.

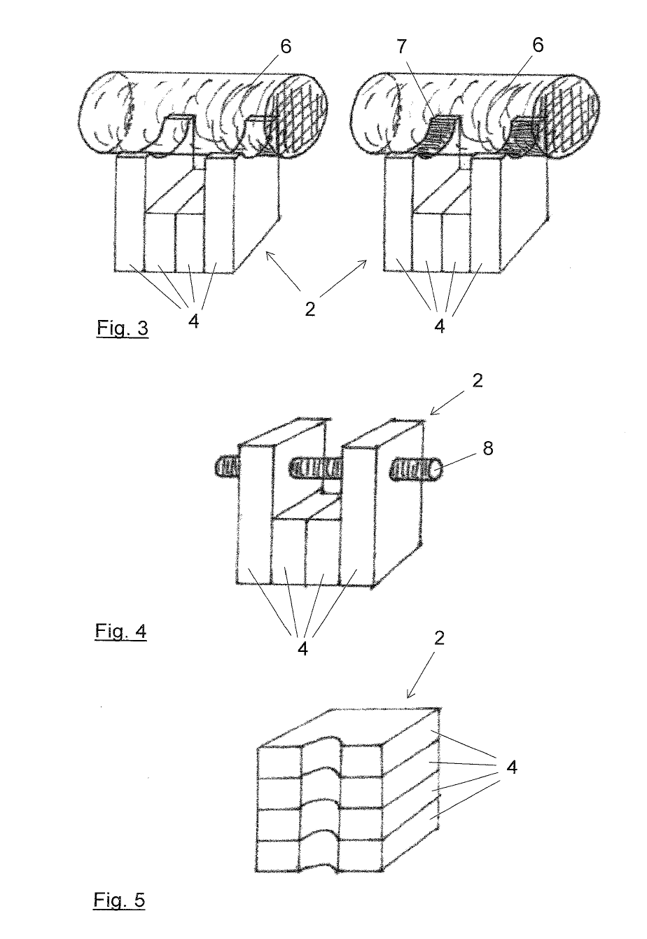

FIG. 3 shows a further example of a possible embodiment of a retaining element 2 for accommodating functional elements. In this example, the upper edges of the two outer thin plates 4 of retaining element 2 have cavities due to previous structuring, for example by cutting out a thin plate with such an external shape, which cavities are of a size designed to accommodate functional element 6, which in this case is cylindrical. In this context, functional element 6, for example an optical fibre, may either only be inserted in the arc-shaped depressions on the edge of outer plates 4 (version on the left), or they may also be bonded in these depressions with adhesive 7, as indicated in the version on the right. The shape of the depression at the edge of plates 4 may be adapted precisely to match the outer shape of the functional element 6 that is to be accommodated.

FIG. 4 shows a further example of a vertically stacked retaining element 2, in which circular passthrough openings have been structured in outer plates 4. These passthrough openings may accommodate an axle 8, for example, which may serve as an axis of rotation for a functional element that is fastened to this axle. This axis of rotation may either be supported rotatably or rigidly, on non-rotatable manner in the openings shown. In addition, a retaining element 2 with passthrough openings of such kind may be used to accommodate a correspondingly designed functional element. For example, an optical fibre may also be passed through the passthrough openings instead of axle 8. In this case, retaining element 2 also serves to accommodate and/or guide the optical fibre.

Finally, FIG. 5 shows a further example of a horizontally stacked retaining element 2. In this example, all thin plates 4 in retaining element 2 are of identical size, and have a corresponding depression at the edge on one side thereof, which depression is realised as a channel-like depression formed by all of the plates together, This recess might in turn accommodate a correspondingly shaped functional element, which might be supported and optionally also secured therein by adhesive bonding.

The embodiments shown only indicate various simple variations of the carrier system and/or the retaining elements. Of course, the retaining elements may also have a considerably more complex design, and in particular may also comprise more than three or four thin plates. Each plate is then dimensioned and shaped laterally according to the desired final shape of the retaining element. Since cutting out and structuring such thin plates is very simple and can be performed with a very high degree of precision, this method can be used in particular to create very complex shapes of the retaining elements with low effort. This applies particularly for retaining elements made from glass or glass ceramics.

### LIST OF REFERENCE SIGNS

1 Base plate
2 Retaining element
3 Thin plates of the base plate
4 Thin plates of the retaining elements
5 Pins
6 Functional element
7 Adhesive
8 Axle

1. Carrier system for micro-optical and/or other functional elements of microtechnology, including a base plate and one or several retaining elements for the functional elements that are secured on the base plate, characterized in that the retaining elements are constructed partly or entirely from thin stacked plates which have a plate thickness of less than 1 mm.

2. Carrier system according to claim 1, characterized in that the thin plates of one or several of the retaining elements are made from glass or glass ceramic.

3. Carrier system according to claim 1, characterized in that the base plate is made from glass or glass ceramic.

4. Carrier system according to claim 1, characterized in that the base plate is also constructed from thin stacked plates, which have a plate thickness of less than 1 mm.

5. Carrier system according to claim 4, characterized in that the thin plates of the base plate are made from glass or glass ceramic.

6. Carrier system according to claim 1, characterized in that the thin plates of the base plate and/or the thin plates of one or several of the retaining elements are connected without adhesive via connection elements.

7. Carrier system according to claim 1, characterized in that the thin plates of the base plate and/or the thin plates of one or several of the retaining elements are connected via a bonding technique.

8. Carrier system according to claim 1, characterized in that one or several of the thin plates of the base plate and/or one or several of the thin plates of one or several of the retaining elements are structured such that they have one or several passthrough openings.

9. Carrier system according to claim 1, characterized in that at least two of the thin plates of the base plate and/or at least two of the thin plates of at least one of the retaining elements have different structural shapes.

10. Carrier system according to claim 1, characterized in that at least some of the thin plates of the base plate and/or at least some of the thin plates of at least one of the retaining elements has/have one or several passthrough apertures to accommodate one or several rotation axles or other elongated bodies.

11. Carrier system according to claim 1, characterized in that in one or several of the retaining elements the stacked thin plates are aligned vertically to the surface of the base plate.

12. Carrier system according to claim 11, characterized in that the thin plates of one or several of the retaining elements are made from glass or glass ceramic.

13. Carrier system according to claim 12, characterized in that the base plate is also constructed from thin stacked plates, which have a plate thickness of less than 1 mm.

14. Carrier system according to claim 13, characterized in that the thin plates of the base plate are made from glass or glass ceramic.
